(19) United States
(12) Patent Application Publication
(10) Pub. No.: US 2003/0046468 A1
(43) Pub. Date: Mar. 6, 2003

(54) High-density system having a plurality of system units

(76) Inventors: Hsiang-Chan Chen, Taipei City (TW); Hung-I Liu, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 09/682,398

(22) Filed: Aug. 30, 2001

(51) Int. Cl. G06F 13/38

(52) U.S. Cl. 710/301

(57) ABSTRACT

A high-density system includes a plurality of system units. Each system unit includes a backplane and a plurality of central processing unit (CPU) cards plugged into the backplane. Each backplane has a servicing input/output (I/O) bus for carrying servicing I/O data. Each central processing unit (CPU) card is plugged into the corresponding backplane and capable of accepting data from the servicing I/O bus or sending data to the servicing I/O bus. The high-density system further includes at least one cable for connecting the servicing I/O busses of the system units so as to transfer the servicing I/O data, and a servicing control system. The servicing control system includes a switching system for selectively connecting only one of the CPU cards in the high-density system to the servicing I/O bus, and an I/O interface module electrically connected to the servicing I/O bus. The I/O interface module has at least a port to which an external device may be plugged. The servicing control system selectively enables only one of the CPU cards in the high-density system to send servicing I/O data to the port or to receive servicing I/O data from the port.

### BACKGROUND OF INVENTION

1. Field of the Invention

The present invention relates to a high-density system. More specifically, the present invention relates to a high-density system having a plurality of system units whose central processing unit cards share a common input/output (I/O) interface module.

2. Description of the Prior Art

Please refer to FIG. 1. FIG. 1 is a block diagram of a prior art computer system 10. The computer system 10 comprises a system unit 11, and the system unit 11 comprises a backplane 14, a plurality of central processing unit (CPU) cards 12 plugged into the backplane 14, and a servicing control system 16. The servicing control system 16 comprises a plurality of input/output (I/O) ports including keyboard ports 22, video ports 24, and mouse ports 26. The servicing control system 16 further comprises a plurality of power switches 28 and a switching system 20 for selectively connecting only one of the CPU cards 12 to the input/output (I/O) ports on the servicing control system 16 by turning on only the power switch 28 corresponding to the selected CPU card 12. Each of the CPU cards 12 has a keyboard port 22, a video port 24 and a mouse port 26. The keyboard port 22, video port 24 and mouse port 26 of the CPU card 12 is connected to the corresponding I/O ports of the servicing control system 16 using cables 40.

As shown in FIG. 1, the keyboard port 22, video port 24 and mouse port 26 of each CPU card 12 are connected to the I/O ports of the servicing control system 16 using cables 40. Therefore, the number of cables 40 will increase when more system units 11 are used, resulting in a great number of cables 40 and making the computer system 10 very messy.

### SUMMARY OF INVENTION

It is therefore a primary objective of this invention to provide a high-density system having a plurality of system units whose CPU cards share a common input/output (I/O) interface module through a servicing I/O bus connected by cables to solve the above mentioned problem.

According to the claimed invention, the high-density system includes a plurality of system units. Each system unit includes a backplane and a plurality of central processing unit (CPU) cards plugged into the backplane. Each backplane has a servicing input/output (I/O) bus for carrying servicing I/O data. Each central processing unit (CPU) card is plugged into the corresponding backplane and capable of accepting data from the servicing I/O bus or sending data to the servicing I/O bus. The high-density system further includes at least one cable for connecting the servicing I/O busses of the system units so as to transfer the servicing I/O data, and a servicing control system. The servicing control system includes a switching system for selectively connecting only one of the CPU cards in the high-density system to the servicing I/O bus, and an I/O interface module electrically connected to the servicing I/O bus. The I/O interface module has at least a port to which an external device may be plugged. The servicing control system selectively enables only one of the CPU cards in the high-density system to send servicing I/O data to the port or to receive servicing I/O data from the port.

It is an advantage of the present invention that all the CPU cards of the high-density system share the common I/O interface module through the servicing I/O bus. Consequently, space inside the high-density system is used efficiently and no cable is needed for signal transmissions.

These and other objectives and advantages of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a prior art computer system.

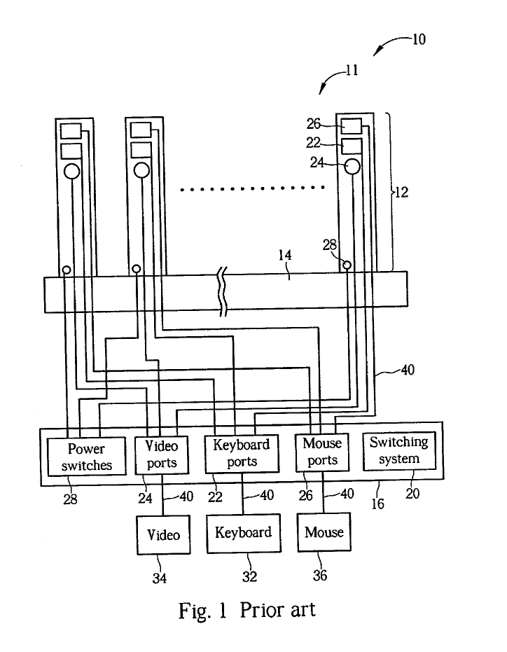

FIG. 2 is a perspective view of a high-density system according to the present invention.

FIG. 3 is a side view of the high-density system in FIG. 2.

FIG. 4 is a data structure diagram of the high-density system in FIG. 2.

FIG. 5 is a functional block diagram of the high-density system in FIG. 2.

### DETAILED DESCRIPTION

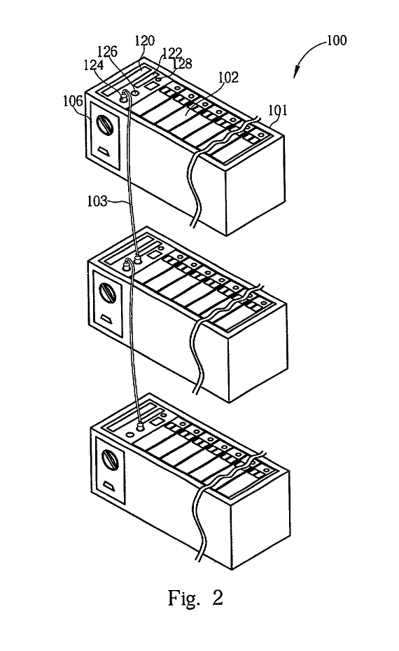

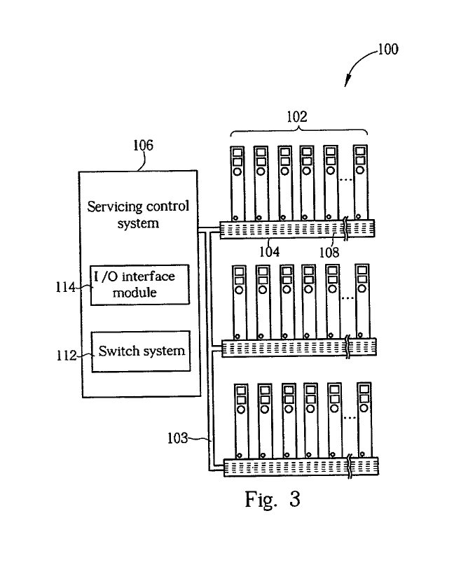

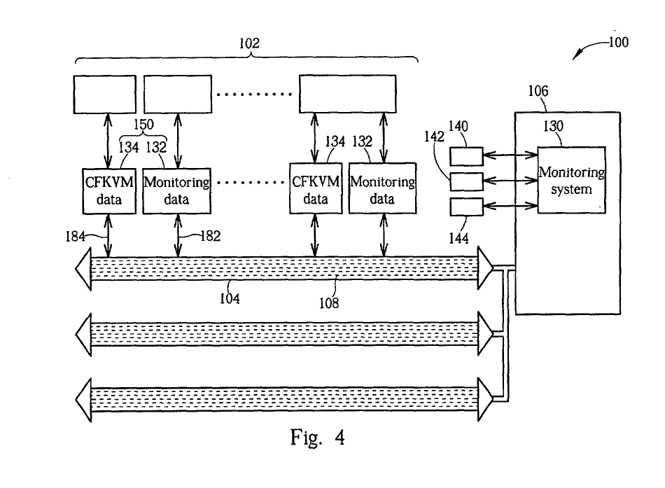

Please refer to FIG. 2 and FIG. 3. FIG. 2 is a perspective view of a high-density system 100 according to the present invention. FIG. 3 is a side view of the high-density system 100. The high-density system 100 comprises three system units 101. Each system unit 101 comprises a backplane 104 and a plurality of central processing unit (CPU) cards 102 plugged in the backplane 104 (as shown in FIG. 3). Each backplane 104 has a servicing input/output (I/O) bus 108 set within the backplane 104 for carrying servicing I/O data. The servicing I/O data is used to manage and monitor the CPU cards 102, and will be illustrated in detail in FIG. 4.

As shown in FIGS. 2 and 3, the CPU cards 102 are plugged into the backplane 104, and can receive data from the servicing I/O bus 108 or transmit data to the servicing I/O bus 108. The high-density system 100 further comprises two flexible cables 103 connected between the servicing I/O busses 108 of the system units 101, and a servicing control system 106 installed in one of the system unit 101 and electrically connected to the servicing I/O busses 108. The servicing I/O data can be transmitted between the servicing I/O busses 108 and the servicing control system 106 through the cables 103.

The servicing control system 106 has a switching system 112 and an I/O interface module 114. The switching system 112 selectively connects only one of the CPU cards 102 to the servicing I/O bus 108 within the backplane 104 while the remaining CPU cards cannot transmit or receive the servicing I/O data. The I/O interface module 114 comprises a CD-ROM 120, a floppy disk drive 122, a keyboard port 124, a video port 128, and a mouse port 126, which are electrically connected to the servicing I/O bus 108. According to the present invention, the I/O interface module 114 comprises at least a port to which an external device (such as a CD-ROM, a mouse etc.) may be plugged, and the servicing control system 106 selectively enables only one of the CPU cards 102 to transmit the servicing I/O data to the port or to receive the servicing I/O data from the port.

Please refer to FIG. 4. FIG. 4 is a data structure diagram of the high-density system 100. As shown, servicing I/O data 150 comprises CFKVM data 134 and monitoring data 132. The CFKVM data 134 includes Compact disk read only memory (CD-ROM) data, Floppy disk drive (FDD) data, Keyboard port data, Video port data and Mouse port data. The servicing control system 106 further comprises a monitoring system 130 for generating monitoring data 132 through the servicing I/O bus 108. The monitoring data 132 includes information such as a rotational speed of a system fan 140, a system temperature 142, a system voltage 144 and the status of each of the CPU cards 102.

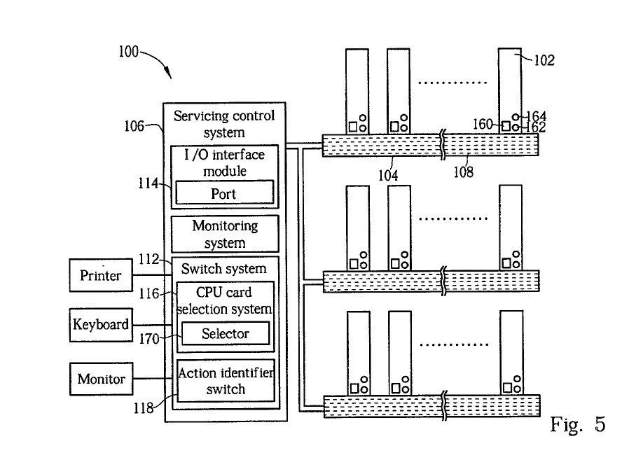

Please refer to FIG. 5. FIG. 5 is a functional block diagram of the high-density system 100 in FIG. 2. The switching system 112 comprises a CPU card selection system 116, and an action identifier switch 118. Moreover, the switching system 112 comprises a bus switch 160, a reset switch 162 and a power switch 164 on each CPU card 102. The CPU card selection system 116 is electrically connected to each bus switch 160 and has a selector 170 that enables a user to select only one of the CPU cards. In addition, the bus switch 160 on each CPU card 102 is used to selectively connect the CPU card 102 to the servicing I/O bus 108, or disconnect the CPU card 102 from the servicing I/O bus 108, according to an identifier that is chosen by the action identifier switch 118. Whenever a CPU card 102 is selected by the user according to the selector 170, the CPU card selection system 116 transmits the corresponding identifier to the bus switch 160 of the CPU card 102 to connect the CPU card 102 to the servicing I/O bus 108.

The reset switch 162 of the switching system 112 on each CPU card 102 is electrically connected to the CPU card selection system 116 to selectively reset the CPU card 102 according to a reset identifier. Furthermore, the power switch 164 of the switching system 112 on each CPU card 102 is electrically connected to the CPU card selection system 116 to selectively supply power to the CPU card 102 according to a power identifier. Whenever a CPU card 102 is selected by the user according to the selector 170, the CPU card selection system 116 sends the corresponding reset identifier or power identifier to the reset switch 162 or the power switch 164, respectively, of the CPU card to reset the CPU card, turn power on to the CPU card, or turn power off for the CPU card according to the action identifier switch 118.

In contrast to the prior art, the backplane 104 of each system unit 101 of the high-density system 100 has a servicing input/output (I/O) bus 108 set within for carrying servicing I/O data. Therefore, fewer cables are required for interconnecting I/O ports of the CPU cards 102 with the I/O interface module 114, and spaces inside the system units 101 are not wasted on messy connections of cables.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A high-density system comprising:
a plurality of system units, each system unit comprising:
a backplane having a servicing input/output (I/O) bus for carrying servicing I/O data;
a plurality of central processing unit (CPU) cards plugged into the backplane and capable of accepting data from the servicing I/O bus or sending data to the servicing I/O bus;
at least one cable for connecting the servicing I/O busses of the system units so as to transmit the servicing I/O data; and
a servicing control system comprising:
a switching system for selectively connecting only one of the CPU cards in the high-density system to the servicing I/O bus; and
an I/O interface module electrically connected to the servicing I/O bus, the I/O interface module comprising at least a port to which an external device may be plugged;
wherein the servicing control system selectively enables only one of the CPU cards in the high-density system to send servicing I/O data to the port or to receive servicing I/O data from the port.

2. The high-density system of claim 1 comprises a plurality of cables and each cable connects two of the servicing I/O busses of the system units for transmitting servicing I/O data.

3. The high-density system of claim 1 wherein the I/O interface module comprises a compact disk read only memory (CD-ROM), a floppy disk drive (FDD), a keyboard port, a video port, or a mouse port.

4. The high-density system of claim 1 wherein the servicing I/O data comprises CD-ROM data, FDD data, keyboard port data, video port data, mouse port data, or monitoring data.

5. The high-density system of claim 4 wherein the monitoring data provides information about a rotational speed of a system fan, a system temperature, or a system voltage.

6. The high-density system of claim 4 further comprising a monitoring system to provide the monitoring data.

7. The high-density system of claim 1 wherein the switching system comprises:
a bus switch on each CPU card to selectively connect the CPU card to the servicing I/O bus, or disconnect the CPU card from the servicing I/O bus, according to an identifier; and
a CPU card selection system electrically connected to each bus switch and comprising a selector that enables a user to select only one of the CPU cards;
wherein for a CPU card selected by the user according to the selector, the CPU card selection system sends the corresponding identifier to the bus switch of the CPU card to connect the CPU card to the servicing I/O bus.

8. The high-density system of claim 7 wherein when the CPU card selection system sends the corresponding identifier, the bus switches on all other CPU cards disconnect all other CPU cards from the servicing I/O bus.

9. The high-density system of claim 7 wherein the CPU card selection system is disposed within the I/O interface module.

10. The high-density system of claim 7 wherein the switching system further comprises:
a reset switch on each CPU card electrically connected to the CPU card selection system to selectively reset the CPU card according to a reset identifier;
a power switch on each CPU card electrically connected to the CPU card selection system to selectively supply power to the CPU card according to a power identifier; and
an action identifier switch;
wherein for a CPU card selected by the user according to the selector, the CPU card selection system sends the corresponding reset identifier or power identifier to the reset switch or power switch, respectively, of the CPU card to reset the CPU card, turn power on to the CPU card, or turn power off for the CPU card according to the action identifier switch.
